(19) United States
(12) Patent Application Publication
(10) Pub. No.: US 2024/0108537 A1
(43) Pub. Date: Apr. 4, 2024

(54) VARIABLE TEMPERATURE MICROPERCUSSION THERAPY DEVICE

(71) Applicant: Nice Recovery Systems LLC, Boulder, CO (US)

(72) Inventors: Joel Meisinger, Boulder, CO (US); Michael Ross, Boulder, CO (US); Gerry Taylor, Boulder, CO (US)

(21) Appl. No.: 17/957,676

(22) Filed: Sep. 30, 2022

(51) Int. Cl. A61H 23/00; A61H 23/02

(52) U.S. Cl. CPC A61H 23/006; A61H 23/02; A61H 2201/0207; A61H 2201/0214; A61H 2201/0257; A61H 2201/0285; A61H 2201/1207; A61H 2201/1669; A61H 2201/5007; A61H 2201/5046

(57) ABSTRACT

An electronic device for temperature adjustable massage therapy. The device includes a temperature-controlled applied surface for delivering micropercussions to a user. In one example, the device is adapted to be adjusted to any number of different temperatures, and is further adapted to perform percussive therapy at any number of different amplitudes and/or frequencies. The user may engage a touch screen to adjust the temperature, amplitude, and/or frequency of the device.

### CROSS-REFERENCE TO RELATED APPLICATIONS

This application is filed as original and makes no priority claim.

### TECHNICAL FIELD

Embodiments of the present disclosure relate to an electronic device for temperature adjustable massage therapy, wherein the device is adapted to perform micropercussions. In one example embodiment, the electronic device for temperature adjustable massage therapy is adapted to be adjusted to any number of different temperatures, and is further adapted to perform percussive therapy, preferably using micropercussions, at any number of different amplitudes and/or frequencies.

### BACKGROUND AND SUMMARY OF THE INVENTION

Traditionally, massage therapy has been performed by hand or with non-motorized devices or apparatus. An issue with traditional massage therapy is the human ability to engage tissues at certain speeds, ranges of motion, patterns, some combination thereof, or the like is limited. Motorized massage has enabled massage therapy to occur without the same speed, range of motion, or pattern restrictions present with traditional massage therapy. A non-limiting example of a motorized massage machine is a percussive therapy massage apparatus. A percussive therapy massage apparatus is an apparatus having a reciprocating member having a distal end configured to apply a force to a tissue during each reciprocation of the member. One advantage of therapy involving a percussive therapy massage apparatus (referred to herein as “percussive massage therapy”) is that a substantial number of forces to a tissue may be exerted over a short amount of time to promote certain muscle benefits.

An issue with prior art percussive massage therapy is that the prior art percussive therapy massage apparatuses (referred to herein as “prior apparatus”) lack real time micropercussion adjustment control (where “micropercussions” are defined as percussions caused by a reciprocating member stroke of less than or equal to 5 mm) (where “stroke” or “amplitude” is defined as the maximum difference in distance of the position of the front of the reciprocating member when the member is in an extended position compared to a retracted position) and real time device temperature adjustment control.

One issue with having larger percussions caused by greater stroke of a reciprocating member is that prolonged exposure to larger percussions, especially at higher frequencies (where “frequency” is defined as the number of pulses or percussions, achieved when the reciprocating member moves from a retracted position to an extended position, occurring in a certain amount of time), can have adverse effects on muscle tissue. By way of example and not limitation, a condition called rhabdomyolysis, which involves damage to muscle fibers, may result from prolonged exposure to larger percussions. One issue with lacking device temperature control is that although heating pads, ice packs and the like are well-known, it may be difficult or impossible to administer a percussive therapy massage apparatus and a heating pad, ice pack or the like to the same surface area of a body simultaneously.

The aforementioned shortcomings speak to the need for a therapy device permitting a user to have real time control over device temperature (specifically, the portion(s) of the device contacting a user's body) and micropercussion stroke, frequency, and local vibrations of a reciprocating member.

It is an object of the present invention to provide a lightweight, durable and affordable massage therapy device useful for promoting and maintaining muscle comfort, health, strengthening, flexibility, some combination thereof, or the like.

In view of the prior art shortcomings and the aforementioned object, exemplary embodiments of the present invention provide a variable temperature micropercussion therapy device.

According to the present invention in one aspect, an exemplary device comprises a device body, an applied surface, a thermal engine and a handle. By way of example and not limitation, the handle may permit the device to be held in a hand of a single user, who, using the device, may apply micropercussion therapy to oneself or another individual. The applied surface preferably comprises an amount of silicon carbide, a similar conductive or semi-conductive material, or some combination thereof in a conductive or semi-conductive plate, chip, or the like. The applied surface may be configured to transfer heat to a portion of a user's body. The applied surface may also be configured to reduce heat at a portion of a user's body. The applied surface may also include a thermoelectric surface. It will be apparent to one of ordinary skill in the art that any number of different conductive and/or thermoelectric surfaces may be incorporated at the applied surface without departing from the scope of the present invention.

In certain exemplary embodiments of the present invention, the temperature of the applied surface may be adjusted between 10° F. and 140° F. In certain exemplary embodiments of the present invention, one or more reciprocating members directed to the applied surface move back and forth in an oscillating fashion at an amplitude between 0.5 mm and 5 mm, wherein the amplitude and frequency of reciprocating member movement may be adjusted in real time by a central controller of the device. It will be apparent to one of ordinary skill in the art that exemplary embodiments of the present invention are not necessarily intended to be limited to any particular temperature, stroke or frequency range. By way of example and not limitation, even higher temperatures (higher than 140° F.) and even lower temperatures (lower than 10° F.) at the applied surface may be set. A screen providing digital interfaces, a plurality of buttons, rotatable dials, some combination thereof, or the like may be positioned on the device, and may provide user adjustable control of reciprocating member amplitude and/or frequency (e.g., pulses/percussions per minute, or ppm), and may also provide user adjusted control over applied surface temperature, as well as magnitude of local vibrations occurring at the applied surface. It will also be apparent to one of ordinary skill in the art that exemplary embodiments of the present invention are not necessarily intended to be limited to any particular local vibration magnitude.

A central controller for the device may specifically comprise a full color touch screen at the rear of the device. Digital interfaces of the touch screen may provide options for a user to specify and/or adjust amplitude, frequency, local vibrations, applied surface temperature, some combination thereof, or the like in real time before and/or during a treatment session. The central controller may permit the user to specify a treatment option involving thermal therapy only. The central controller may also permit the user to specify a treatment option involving micropercussion therapy only. The central controller may further permit the user to specify a treatment option involving both thermal therapy and micropercussion therapy. The central controller may additionally permit the user to specify a treatment option involving a variety of different parameters varied throughout the course of a single treatment session. By way of example and not limitation, a contrast therapy option may permit a user to have an applied surface initially reduce heat at a surface area of a body during a treatment session, then later increase heat at the surface area, then reduce heat again, and then increase heat again in a repeating fashion according to any number of different durations.

As another example not by way of limitation, a contrast therapy option may permit a user to have an applied surface initially provide very small micropercussions, followed by larger micropercussions. A battery, preferably a rechargeable battery, may be positioned in an interior portion of the device. In certain embodiments, the battery is rechargeable according to USB C power delivery. The battery may supply power to a brushless motor adapted to cause micropercussions at the applied surface. It will be apparent to one of ordinary skill in the art that the present invention is not intended to be limited to any particular power supply or mechanism.

Temperature variable micropercussion therapy may be useful to treating any number of different musculoskeletal issues, such as strains, other sports injuries, or the like, and may also be beneficial for post-surgical rehabilitation. Exemplary embodiments of the present invention may be useful to physical therapists, athletic trainers, physical therapy patients, athletes, home users, and any number of other individuals seeking to promote and maintain desired muscle comfort, health, strengthening, flexibility, some combination thereof, or the like. Exemplary micropercussions according to preferred embodiments may be beneficial in reducing the risk of damage to muscle fiber, rhabdomyolysis, and other adverse effects resulting, by way of example and not limitation, from prolonged exposure to large percussive strokes after exercise. According to a non-limiting example of an exemplary use of a preferred embodiment, a user may loosen up one's muscles with small strokes and heat, and thereafter maximize treatment efficiency by exposing the same muscles to larger strokes at cooler temperatures.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective cross-sectional view of an interior of an exemplary variable temperature micropercussion therapy device;

FIG. 2 illustrates a diagram of an interior of an exemplary variable temperature micropercussion therapy device;

FIG. 3 illustrates exemplary logic of electronic components of an exemplary variable temperature micropercussion therapy device;

FIG. 4 illustrates a front plan view of an exemplary variable temperature micropercussion therapy device;

FIG. 5 illustrates a front view of the exemplary device of the FIG. 4 embodiment;

FIG. 6 illustrates a perspective view of an exemplary variable temperature micropercussion therapy device;

FIG. 7 illustrates another perspective view of the exemplary device of the FIG. 6 embodiment;

FIG. 8 illustrates a top view of the exemplary device of the FIG. 6 embodiment;

FIG. 9 illustrates a top view of an alternative exemplary variable temperature micropercussion therapy device;

FIG. 10 illustrates a perspective view of the exemplary device of the FIG. 9 embodiment;

FIG. 11 illustrates another perspective view of the exemplary device of the FIG. 9 embodiment;

FIG. 12 illustrates various views of another alternative exemplary variable temperature micropercussion therapy device;

FIG. 13 illustrates a perspective view of the exemplary device of the FIG. 12 embodiment;

FIG. 14 illustrates another perspective view of the exemplary device of the FIG. 12 embodiment;

FIG. 15 illustrates various views of another alternative exemplary variable temperature micropercussion therapy device;

FIG. 16 illustrates a perspective view of the exemplary device of the FIG. 15 embodiment;

FIG. 17 illustrates another perspective view of the exemplary device of the FIG. 15 embodiment;

FIG. 18 illustrates various views of another alternative exemplary variable temperature micropercussion therapy device;

FIG. 19 illustrates a perspective view of the exemplary device of the FIG. 18 embodiment;

FIG. 20 illustrates another perspective view of the exemplary device of the FIG. 18 embodiment; and

FIG. 21 illustrates exemplary logic for various device interfaces in accordance with a preferred embodiment of the present invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

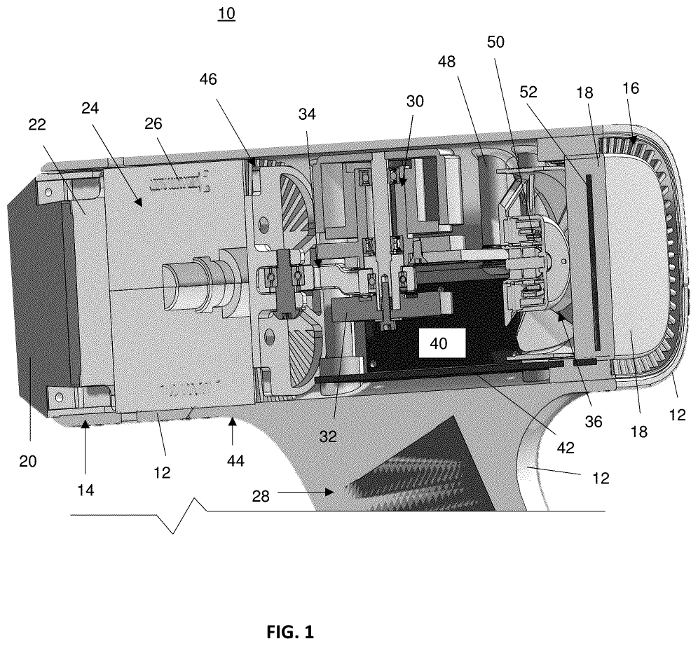

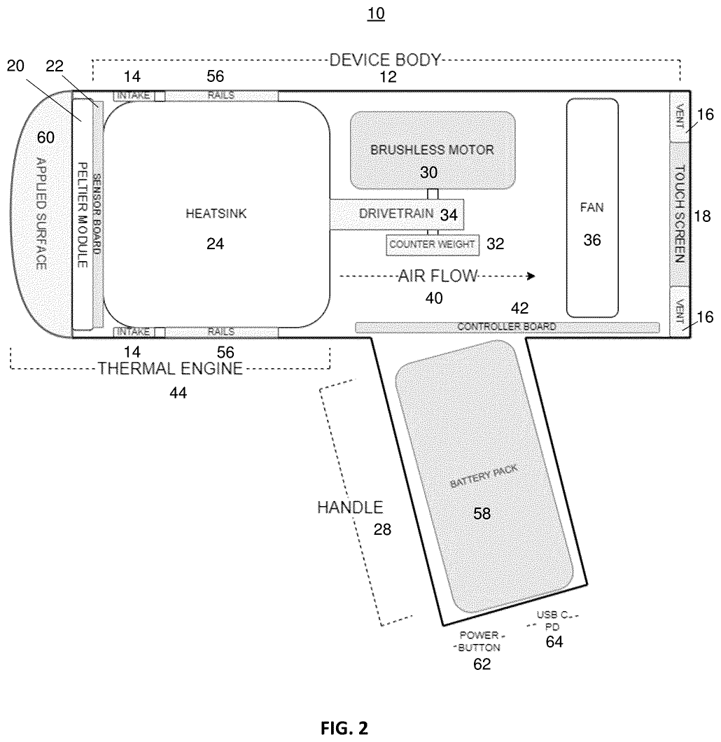

Referring now to FIGS. 1-2, an interior of an exemplary variable temperature micropercussion therapy device 10 is shown. In this particular embodiment, a thermoelectric engine 44 positioned in a device 10 housing or body 12 comprises an applied surface 60, Peltier module 20, heatsink 24, and fan 36. The Peltier module 20 may be any thermoelectric surface or combination of surfaces adapted to receive various amounts of electric current therethrough to achieve a desired surface temperature thereof. The source of electric current may be a battery pack 58 located at the handle 28 and configured to be charged by a USB C (e.g., 64) adapted power cord. Although not shown, certain embodiments may include a removable plug-in head adapted to attach to the device 10 to provide another massage surface. By way of example and not limitation, the handle 28 may permit the device 10 to be held in a hand of a single user, who, using the device, may apply micropercussion therapy to oneself or another individual.

In the embodiment shown, the applied surface 60 is mechanically driven by one or more reciprocating members (e.g., drivetrain 34) in mechanical communication with a brushless electric motor 30 configured to cause movement thereof, which may cause oscillation of the applied surface 60. In an exemplary embodiment, the amplitude of the oscillations range from 0.5 mm to 5 mm, wherein a user may adjust the amplitude in real time before or during treatment using a central controller. The brushless electric motor may be substantially secured by a counterweight 32 positioned in proximity thereto within the device body 12. Further positioned in the device body 12 may be a controller board 42 for regulating various components of the device. A touch screen 18 may provide any number of different digital interfaces providing user ability to specify and/or adjust any number of different device 10 parameters including by way of example and not limitation, amplitude, frequency, temperature, local vibrations at the applied surface 60, off/on status of the device 10, some combination thereof, or the like. In this particular embodiment, the touch screen 18 is an LCD screen regulated by an LCD circuit board 52. It will be apparent to one of ordinary skill in the art, however, that any number of different displays may be employed without departing from the scope of the present invention.

The applied surface 60 may comprise an amount of biocompatible ceramic, silicon carbide, a similar conductive or semi-conductive material, or some combination thereof in a conductive or semi-conductive plate, chip, or the like. Preferably, the applied surface exhibits a thermal conductivity greater than 50 W/mK. A thermostat (not shown) may be configured to remove power from the thermal engine 44 if heating beyond a threshold parameter is detected. A power button or switch 62 may provide user control of when the device 10 is active, and may be illuminated for ease of access when lighting is limited. The device 10 may further include at least one light that illumes when the device is in operation, charging, or the like. The applied surface may be configured to achieve temperatures between 10° F. and 140° F. It will be apparent to one of ordinary skill in the art that exemplary embodiments of the present invention are not necessarily limited to any particular amplitude and/or temperature range. It will also be apparent to one of ordinary skill in the art that exemplary embodiments of the present invention may be used in combination with any number of different therapeutic gels, oils, medicines, some combination thereof, or the like, wherein the device may assist with the application, spread, and cutaneous absorption of said therapeutic gels, oils, medicines, some combination thereof, or the like.

In certain exemplary embodiments, the applied surface 60 is adapted to reach a target temperature within 2 minutes of starting at an initial temperature of 70° F. In certain exemplary embodiments, the frequency of oscillations at the applied surface 60 ranges from approximately 1500 ppm to 3600 ppm. In certain preferred embodiments, frequency is adjustable in 100 ppm intervals. In other exemplary embodiments, micro-frequencies at or below 900 ppm are available for less vigorous treatment. It will be apparent to one of ordinary skill in the art that exemplary embodiments of the present invention are not necessary intended to be limited to any particular frequency range. The applied surface 60 may have a stall force of at least 15 lbs. The device may be configured to operate continuously for at least 45 minutes on a substantially high or low temperature setting and maximum frequency percussions.

The applied surface 60 may be configured to transfer heat to a portion of a user's body. The applied surface 60 may also be configured to reduce heat at a portion of a user's body. The applied surface may also include a thermoelectric surface. It will be apparent to one of ordinary skill in the art that any number of different conductive and/or thermoelectric surfaces may be incorporated at the applied surface without departing from the scope of the present invention. A sensor board 22 may be positioned in close proximity to the Peltier module 20, and may be configured to cause voltage or current applied to the Peltier module 20 to be adjusted according to a thermal control loop until, for example not by way of limitation, a desired temperature of the applied surface 60 is achieved. By way of example and not limitation, voltage applied to the Peltier module may be regulated according to a Pulse Width Modulation (PMW) stage on the output of the power supply to the Peltier module. It will be apparent to one of ordinary skill in the art that although Peltier modules are illustrated and described herein, any number of different thermoelectric modules may be suitable for exemplary embodiments of the present invention.

Air intake apertures 14 may be positioned on the device body 12 to contribute air for airflow pathways (e.g., 40) in the device 10. In some embodiments, filters may be positioned at or near the intakes 14 to prevent contaminants from ambient air from entering the device 10. In this particular embodiment, a plurality of rails 56 are in thermal communication with a heat sink 24 in thermal communication with the sensor board 22 and Peltier module 20. Airflow 40 from the air intake(s) 14 may pass through the rails 56 and transfer sensible heat from the rails 56, and thus transfer sensible heat away from the components (e.g., 24, 22, 20) in thermal communication with the rails 56 to regulate temperature of said components and the applied surface 60. The heat sink 24 may also incorporate a thermal engine drive plate 46 for promoting heat transfer. Airflow 40 may also directly contact the heat sink 24 and transfer sensible heat therefrom. The airflow 40 may subsequently flow through the device body 12 and exit the device 10 through one or more vents 16. Movement of the fan 36 may cause air to flow through the device 10 by way of convection and pressure gradients. In this particular embodiment, blades of the fan 36 are adapted to rotate around an inner portion 50 of the fan 36 to promote airflow. It will be apparent to one of ordinary skill in the art that any number of different fans or other devices configured to promote airflow may be employed without departing from the scope of the present invention. The components may be secured within the device body 12 by any number of different fasteners (e.g., 26), clips, adhesives, welding, pins, brackets, some combination thereof, or the like. Referring specifically to FIG. 1, interior support columns 48 may be positioned in the device 10 to promote structural integrity of the device 10.

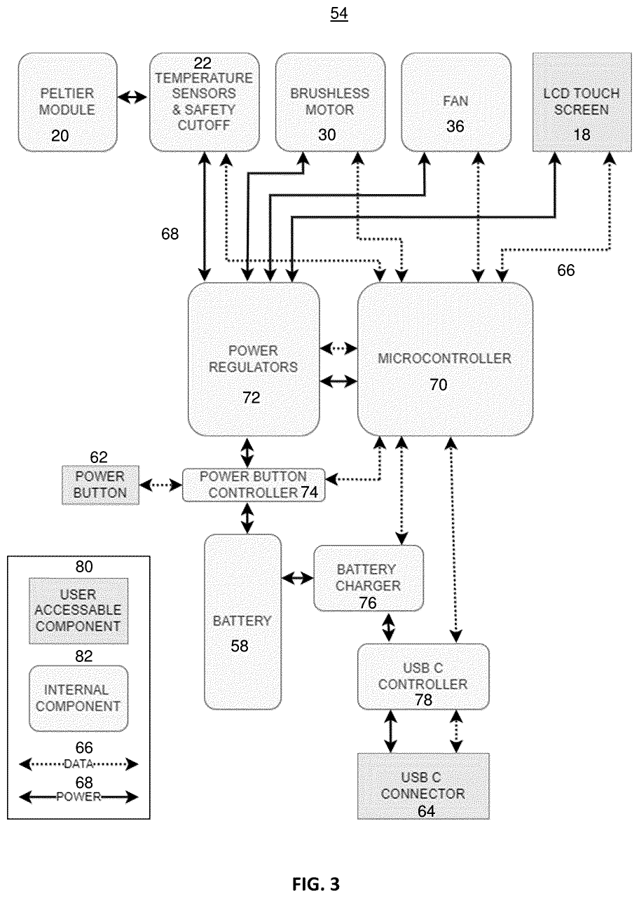

Referring now to FIG. 3, electronic components of an exemplary variable temperature micropercussion therapy device 54 are shown. In this particular embodiment, a Peltier module 20 is an internal component 82 in power communication 68 with temperature sensors and a safety cutoff 22. The temperature sensors and safety cutoff 22 may be an internal component 82 in power communication 68 with power regulators 72, and data communication 66 with a microcontroller 70. The brushless motor 30 may be an internal component 82 in power communication 68 with power regulators 72, and data communication 66 with the microcontroller 70. The fan 36 may be an internal component 82 in power communication with power regulators 72, and data communication 66 with the microcontroller 70. An LCD touch screen 18 may be a user accessible component 80 in power communication with power regulators 72, and data communication 66 with the microcontroller 70. The microcontroller 70 and power regulators 72 may be in both power 68 and data 66 communication with one another.

The microcontroller 70 may be in data communication 66 with a power button controller 74, a battery charger 76, and a USB C controller 78. The power button controller 74 may be in power communication 68 with the battery 58 and power regulators 72, and may be in data communication 66 with the power button 62. The battery 58 and battery charger 76 may be in power communication 68 with one another. The battery charger 76 may be in power communication 68 with the USB C controller 78, which may be in power communication 68 and data communication 66 with the USB C connecter 64. In addition to having a power button 62, the device 54 may further comprise a timeout sleep mode to conserve power after, for example by way of illustration and not limitation, a certain amount of time has passed since the device 54 has been turned on and not engaged.

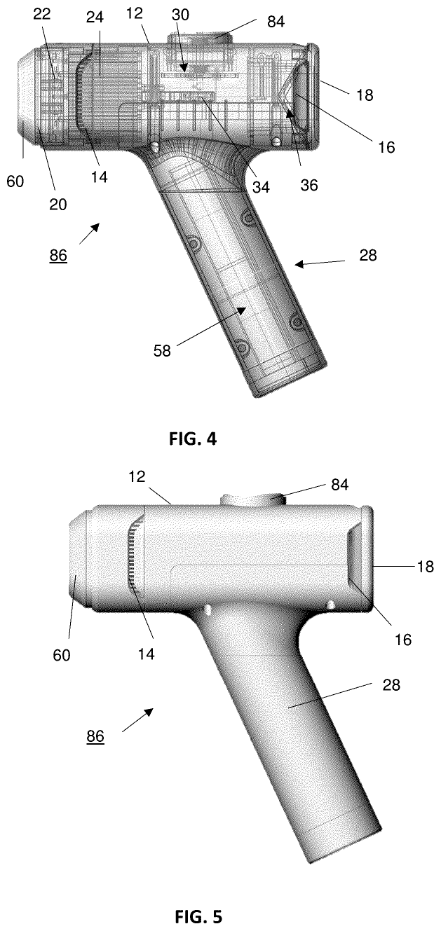

Referring to FIGS. 4-5, an exemplary variable temperature micropercussion therapy device 86 comprising a body 12, screen 18, Peltier module 20, sensor board 22, heat sink 24, applied surface 60, handle 28, air intakes 14, battery pack 58, fan 36, vents 16, brushless motor 30, and drivetrain 34 is shown. The device may also include a protrusion 84 adapted to receive a portion of the brushless motor 30. In certain exemplary embodiments, the batteries 58 may be charged from a dead battery state to a fully charged state in less than 2 hours. The overall weight of the device is preferably less than 1.5 kg. However, it will be apparent to one of ordinary skill in the art that an exemplary variable temperature micropercussion therapy device may be manufactured in any number of different shapes and/or sizes without departing from the scope of the present invention.

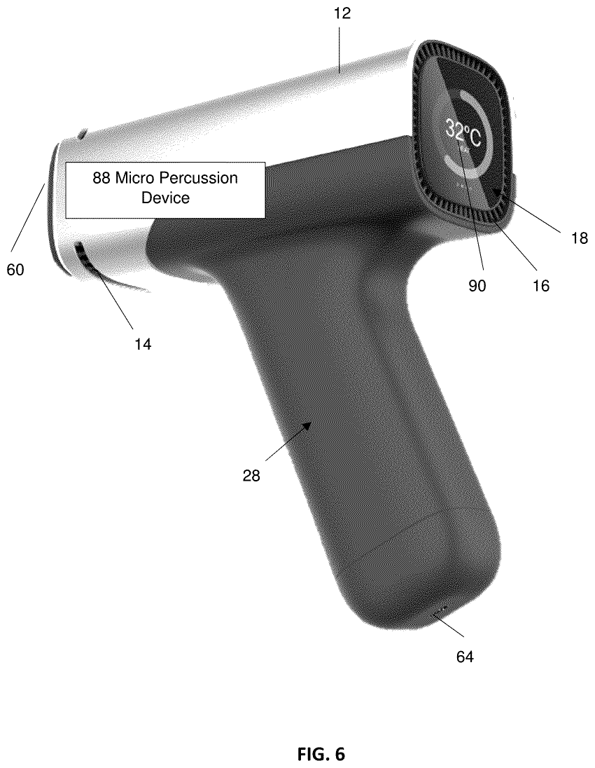

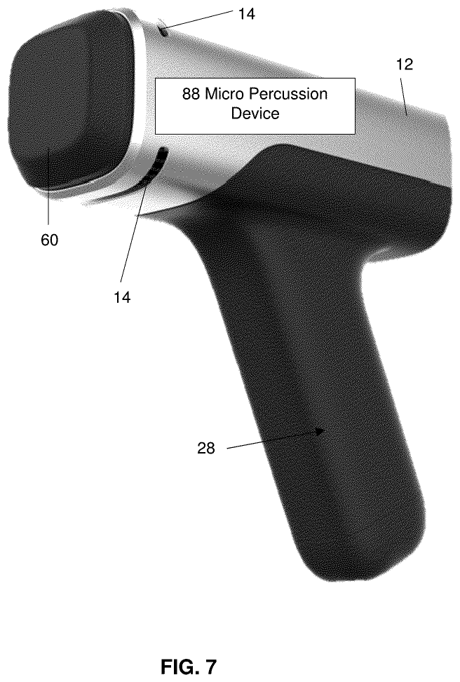

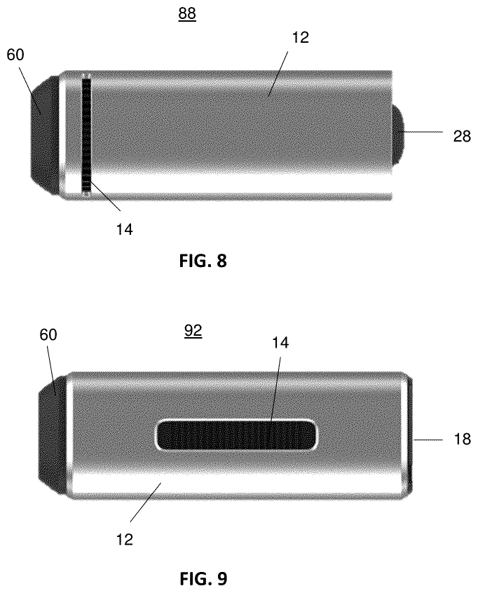

Referring now to FIG. 6-8, another exemplary variable temperature micropercussion therapy device 88 is shown, the device 88 having a handle 28, body 12, USB-C connectivity 64, air intakes 14 near the applied surface 60, and vents 16 near a touch screen 18 displaying real time adjustable temperature 90, which may be adjusted before and/or during use of the device 88. A user may engage the touch screen 18 to direct the device 88 in real time before and/or during use to operate in a temperature only mode, a micropercussion only mode, a combination mode, or the like. In some embodiments, the user may engage the touch screen 18 to cause the applied surface 60 to provide local vibrations. The user may be able to assign Fahrenheit, Celsius, some combination thereof, or the like as preferred displayed temperature units. The touch screen 18 may include a pause and/or stop therapy selection option. In certain preferred embodiments, minimum screen resolution of the touch screen 18 is 200×200.

It will be apparent to one of ordinary skill in the art that exemplary central controllers are not necessarily limited to touch screens. Any screen providing digital interfaces, a plurality of buttons, rotatable dials, some combination thereof, or the like may be positioned at or near the rear of the device, and may provide user control of reciprocating member amplitude and/or frequency (e.g., pulses/percussions per minute, or ppm), and may also provide user control over applied surface temperature, as well as magnitude of local vibrations occurring at the applied surface. It will also be apparent to one of ordinary skill in the art that exemplary embodiments of the present invention are not necessarily intended to be limited to any particular local vibration magnitude.

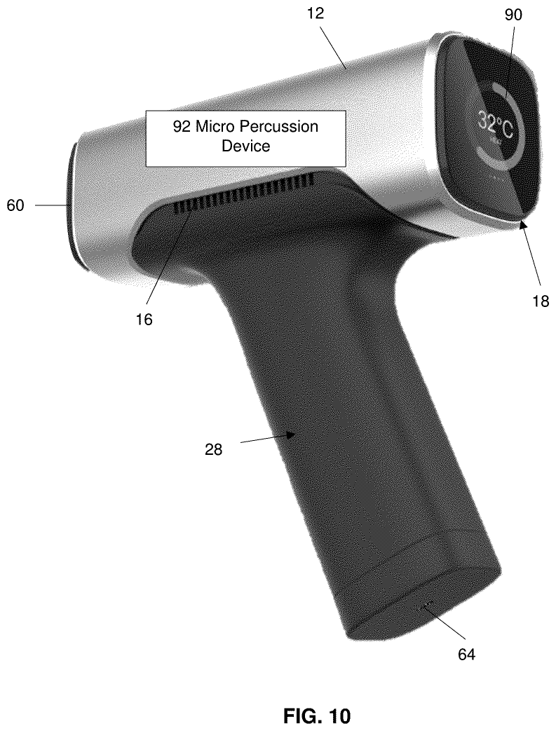

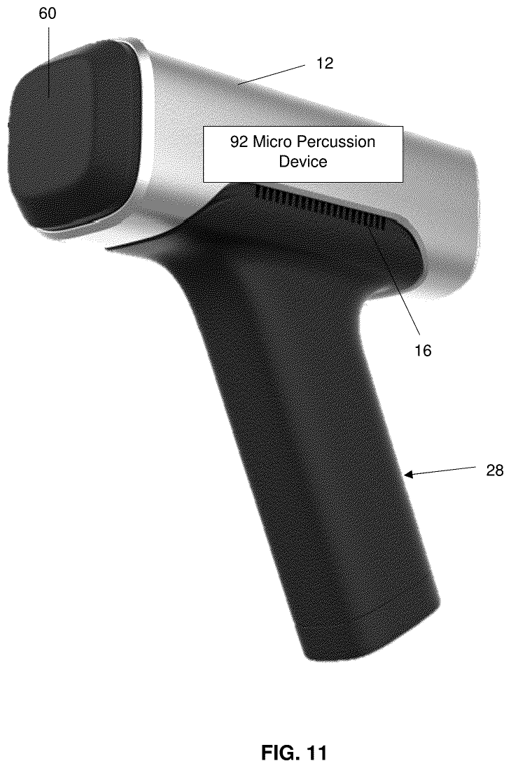

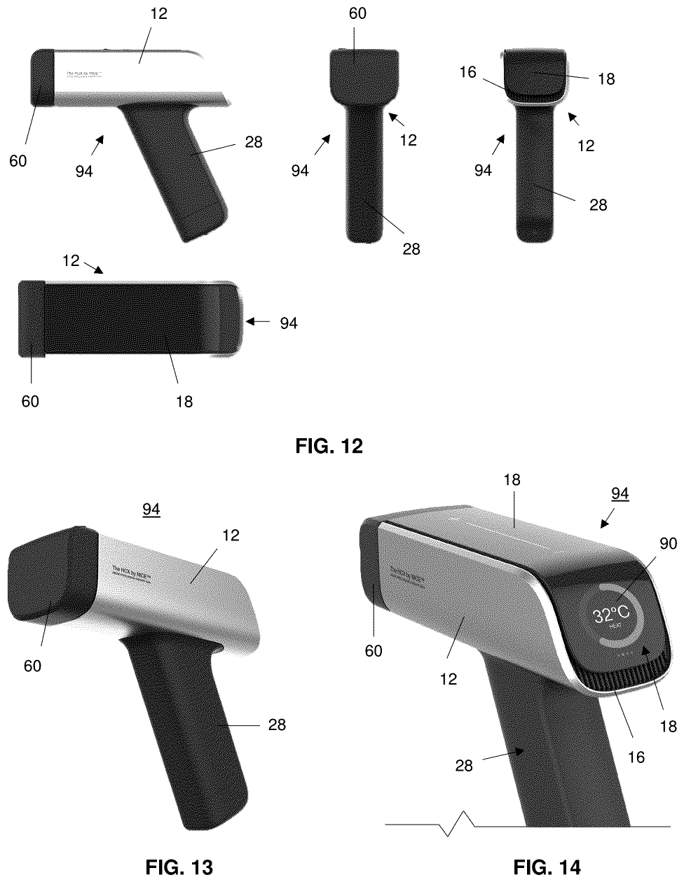

Referring to FIGS. 9-11, another exemplary variable temperature micropercussion therapy device 92 is shown, the device 92 having a handle 28, body 12, USB-C connectivity 64, air intakes 14 at the top of the body 12 behind the applied surface 60, and vents 16 at either side of the body 12. A touch screen 18 may display real time adjustable temperature 90. Referring now to FIGS. 12-14, another exemplary variable temperature micropercussion therapy device 94 is shown, the device 92 having a handle 28, body 12, applied surface 60, and vents 16 below a touch screen 18 displaying real time adjustable temperature 90. In this particular embodiment, the touch screen 18 extends to the top of the device 94 body 12, where temperature may be adjusted thereon. In exemplary embodiments, the device is configured for holding by users of any number of different hand sizes, including small hand sizes below a 2-inch palm and 6-inch hand length. The user may be able to hold the device with one hand, and modify settings of the device on the touch screen 18 with the other hand. In certain preferred embodiments, the device is less than 1400 cubic centimeters in volume, excluding the handle.

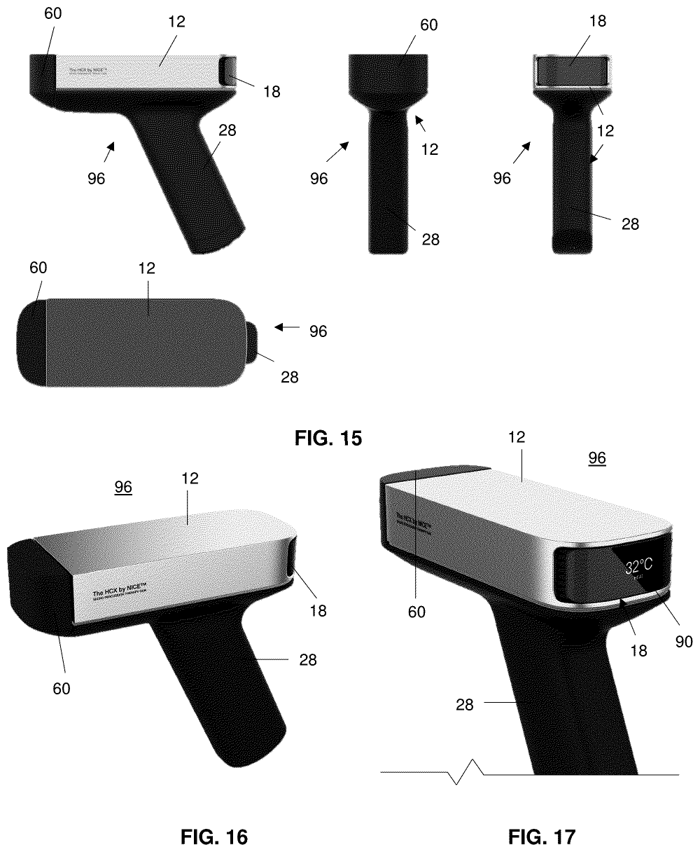

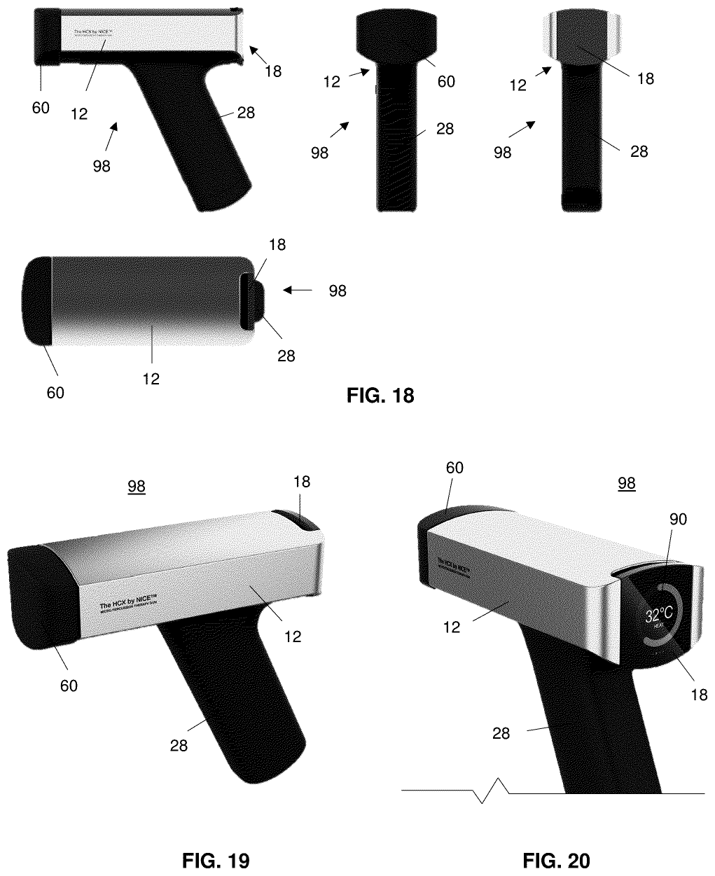

Referring to FIGS. 15-17, yet another exemplary variable temperature micropercussion therapy device 96 is shown, the device 96 having a handle 28, body 12, applied surface 60, and a touch screen 18 displaying real time adjustable temperature 90. In this particular embodiment, the touch screen 18 is positioned at the rear of the device 94 body 12, where temperature may be adjusted thereon. Referring now to FIGS. 18-20, yet another exemplary variable temperature micropercussion therapy device 98 is shown, the device 98 having a handle 28, body 12, applied surface 60, and a touch screen 18 displaying real time adjustable temperature 90. In this particular embodiment, the touch screen 18 is positioned at the rear of the device 94 body 12, where temperature may be adjusted thereon.

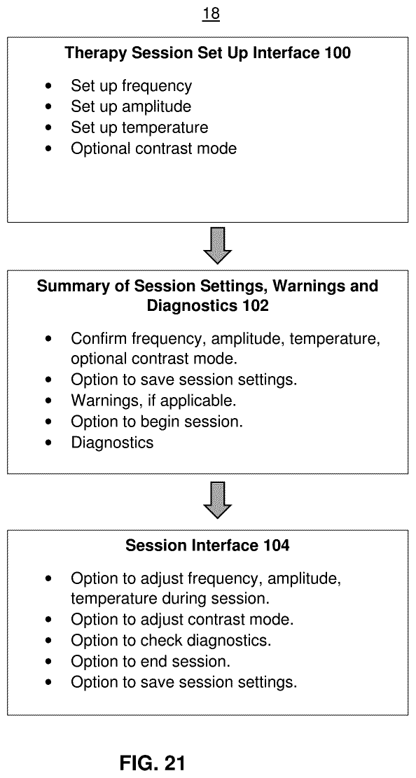

Referring now to FIG. 21, digital interfaces of an exemplary touch screen 18 may include a therapy session set up interface 100, a summary of session settings, warnings and diagnostics interface 102 and a session interface 104. The set-up interface 100 may permit a user to specify temperature, frequency, amplitude, local vibrations, some combination thereof, or the like before a therapy session, and may further permit a user to specify how temperature, frequency, amplitude, local vibrations, some combination thereof, or the like change over time during a therapy session (“optional contrast mode”). The settings, warnings and diagnostics interface 102 may provide an option to confirm aforementioned specifications, save aforementioned specifications for later use, some combination thereof, or the like. The settings, warnings and diagnostics interface 102 may further provide any warnings applicable to certain uses of the device, such as by way of example and not limitation, warnings about prolonged use of the device, especially at very hot or very cold temperatures, and diagnostics options, such as by way of example and not limitation, options to view device performance characteristics. The session interface 104 may provide options to adjust any aforementioned parameters during a therapy session, end a therapy session, save settings from the therapy session, some combination thereof, or the like. The aforementioned interfaces are meant to be merely illustrative and not exhaustive of examples of device programming.

By way of example and not limitation, in the contrast mode, the user may set a lower and an upper temperature for the applied surface that the device may alternate between during a single therapy session. In certain preferred embodiments, temperature dwell time may be specified in intervals of 5 seconds to 10 minutes. In certain preferred embodiments, for applied surface temperature settings below 45° F., a user may first need to acknowledge a warning interface and confirm that the user indeed wishes to experience cold micropercussion therapy and acknowledges the risks of prolonged exposure to cold surfaces. In the contrast mode, a screen display may show a timer indicating time between temperature alternations. The diagnostic screen (e.g., 102) may permit a user to observe general running values, diagnostics, or the like of the running parts of the system such as pumps, fan(s), the thermal engine, some combination thereof, or the like. The device may additionally comprise an electrical hardware watchdog system configured to reset the device when operation of the central controller and/or the controller board are compromised. The device may be configured to continuously run diagnostics tests, and an error or warning message may appear on the user interface when an issue is detected.

Digital interfaces of the touch screen may provide options for a user to specify and/or adjust amplitude, frequency, local vibrations, applied surface temperature, some combination thereof, or the like in real time before and/or during a treatment session. The central controller may permit the user to specify a treatment option involving thermal therapy only. The central controller may also permit the user to specify a treatment option involving micropercussion therapy only. The central controller may further permit the user to specify a treatment option involving both thermal therapy and micropercussion therapy. The central controller may additionally permit the user to specify a treatment option involving a variety of different parameters varied throughout the course of a single treatment session. By way of example and not limitation, a contrast therapy option may permit a user to have an applied surface initially reduce heat at a surface area of a body during a treatment session, then later increase heat at the surface area, then reduce heat again, and then increase heat again in a repeating fashion according to any number of different durations.

As another example not by way of limitation, a contrast therapy option may permit a user to have an applied surface initially provide very small micropercussions, followed by larger micropercussions. It will be apparent to one of ordinary skill in the art that stroke, frequency, temperature, local vibrations, and the like may be varied in real time before and/or during treatment according to any number of different durations and/or patterns without departing from the scope of the present invention.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. An adjustable percussive therapy device comprising:
an applied surface;
a motor;
a controller;
a thermoelectric surface, positioned adjacent to the applied surface and in thermal communication therewith;
an air flow pathway;
wherein the motor is adapted to cause reciprocal motion at the applied surface, the amplitude of the reciprocal motion at or below about 5 mm;
wherein the thermoelectric surface is adapted to receive an electric current, and is further adapted to regulate temperature of the applied surface based on received electric current;
wherein the controller is adapted to regulate current directed to the thermoelectric surface; and
wherein the air flow pathway is configured to transfer heat away from a heatsink in thermal communication with the thermoelectric surface.

2. The device of claim 1, further comprising:
a fan, adapted to direct motion of the air flow pathway.

3. The device of claim 1, wherein:
the thermoelectric surface is a Peltier module.

4. The device of claim 1, wherein:
the controller is adapted to regulate reciprocal motion between an unlimited number of different amplitudes at the applied surface by regulating action of a drive train adapted to cause the reciprocal motion.

5. The device of claim 4, wherein:
the controller includes a digital interface positioned on a body of the device.

6. The device of claim 1, wherein:
the applied surface is adapted for temperature adjustment between a temperature at least as low as about 10° F. and a temperature at least as high as about 140° F.

7. The device of claim 4, wherein:
the motor is adapted to cause reciprocal motion at the applied surface, the frequency of the reciprocal motion being between about 1000 ppm and about 4000 ppm.

8. The device of claim 1, wherein:
the applied surface comprises ceramic material.

9. The device of claim 1, wherein:
the applied surface exhibits a thermal conductivity greater than 50 W/mK.

10. An adjustable percussive therapy device comprising:
an applied surface;
a motor;
a controller;
a thermoelectric surface, positioned adjacent to the applied surface and in thermal communication therewith;
an air flow pathway;
a vent;
a drivetrain;
a fan;
wherein the motor is adapted to cause the drivetrain to oscillate to cause reciprocal motion at the applied surface, the amplitude of the reciprocal motion restricted to micropercussions;
wherein the thermoelectric surface is adapted to receive an electric current, and is further adapted to regulate temperature of the applied surface based on received electric current; and,
wherein the controller is adapted to regulate current directed to the thermoelectric surface.

11. The device of claim 10, wherein:
the applied surface is configured to vibrate while the device is active.

12. The device of claim 10, further comprising:
a counterweight adapted to promote motor generated vibration.

13. The device of claim 10, wherein:
the motor is adapted to cause reciprocal motion at the applied surface, the frequency of the reciprocal motion substantially between about 1000 ppm and about 4000 ppm.

14. The device of claim 10, wherein:
the applied surface is adapted for temperature adjustment substantially between about 10° F. and about 140° F.

15. A method for providing percussive tissue therapy comprising:
providing an applied surface;
providing a motor;
providing a controller;
providing a thermoelectric surface, positioned adjacent to the applied surface and in thermal communication therewith;
providing an air flow pathway;
configuring the motor to cause reciprocal motion at the applied surface, the amplitude of the reciprocal motion not exceeding 5 mm;
configuring the thermoelectric surface to receive an electric current, and configuring the thermoelectric surface to regulate temperature of the applied surface based on received electric current;
adapting the controller to regulate current directed to the thermoelectric surface; and
configuring the air flow pathway to transfer heat away from a heatsink in thermal communication with the thermoelectric surface.

16. The method of claim 15, further comprising:
providing a fan, adapted to direct motion of the air flow pathway.

17. The method of claim 15, further comprising:
configuring the controller to regulate reciprocal motion between a plurality of different amplitudes at the applied surface by regulating action of a drive train adapted to cause the reciprocal motion.

18. The method of claim 15, further comprising:
configuring the controller to regulate temperature of the applied surface between a plurality of hot and cold temperatures as relative to a living human body.

19. The method of claim 17, wherein:
the plurality of different amplitudes are invoked automatically during a distinct pre-programmed massage.

20. The method of claim 15, wherein:
the motor is adapted to cause reciprocal motion at the applied surface in variable ppm, over one distinct massage treatment, without stopping the motor.
